(19) United States
(12) Patent Application Publication
(10) Pub. No.: US 2021/0078905 A1
(43) Pub. Date: Mar. 18, 2021

(54) A batch for producing a refractory carbon-bonded brick, a method for producing a refractory carbon-bonded brick and a use of Ti2AlC

(71) Applicant: Refractory Intellectual Property GmbH & Co. KG, Wien (AT)

(72) Inventors: Christina Atzenhofer, St. Gallen (AT); Harald Harmuth, Leoben (AT); Roland Nilica, St. Marein-Feistritz (AT); Norbert Freiberger, Graz (AT)

(21) Appl. No.: 16/629,907

(22) PCT Filed: Aug. 24, 2018
(86) PCT No.: PCT/EP2018/072892

§ 371 Date: Jan. 9, 2020

(30) Foreign Application Priority Data
Oct. 4, 2017 (EP) 17194678.3

(51) Int. Cl. C04B 35/04

(52) U.S. Cl. CPC C04B 35/04; C04B 2235/40; C04B 2235/425; C04B 2235/3843

(57) ABSTRACT

The invention relates to a batch composition for producing a carbon-bonded refractory stone, a method for producing a carbon-bonded refractory stone, and use of Ti₂AlC.

The invention concerns a batch for producing of a refractory carbon-bonded brick, a method for producing of a refractory carbon-bonded brick and the use of Ti₂AlC.

In refractory technology, a “batch” is known to refer to a composition of one or more components or raw materials by which a refractory product can be produced by means of a temperature treatment, i.e. in particular by means of a ceramic firing.

Refractory carbon-bonded bricks are known to be such a refractory product. Such carbon-bonded bricks are manufactured on the basis of a batch comprising a refractory basic component and graphite. These components are mixed together with the addition of a coking binder, usually pitch or synthetic resin, and then subjected to a temperature that causes volatile components of the binder to volatilize. This temperature application is also referred to as “tempering”. If a further temperature is applied, also known as “coking”, the binder cokes. In the tempered or coked state, the brick produced from the batch already has a certain strength and can, for example, be transported to its intended place of use, regularly a plant for the secondary metallurgical treatment of a steel melt, and installed there. Under the temperatures prevailing during operation, the carbon finally forms a carbon bond. Carbon-bonded bricks produced on the basis of the refractory basic component magnesia and a carbon component are also referred to as “magnesia carbon bricks”, and carbon-bonded bricks produced on the basis of the refractory basic components magnesia and alumina and a carbon component are also referred to as “alumina magnesia carbon bricks”.

Such refractory carbon-bonded bricks are characterized by high wear resistance, structural flexibility and thermal shock resistance.

Oxidic refractory raw materials are regularly used as basic components, in particular raw materials based on magnesia, raw materials based on alumina and raw materials based on magnesia spinel.

For the carbon components, raw materials are used which consist predominantly of free carbon, in particular graphite and carbon black.

In order to suppress an oxidation of the carbon of the carbon component, especially during the production of the brick from the batch, it is known to provide the batch with so-called antioxidants. Particularly effective antioxidants are metal powders made of aluminum and aluminum alloys such as Al—Si or Al—Mg. Such antioxidants based on metallic aluminum can suppress an oxidation of the carbon of the carbon component. However, at the high temperatures during operation of the carbon-bonded brick, the metallic aluminum reacts with the carbon of the carbon-bonded brick to Al₄C₃ according to the following equation:

4 Al+3 C=Al₄C₃

The presence of this aluminum carbide Al₄C₃ is unproblematic during the high temperatures during the operation of the brick. However, Al₄C₃ hydrates very easily at room temperature. This can lead to the carbon bonded brick forming aluminum hydroxide during cooling, e.g. after use, according to the following equation:

Al₄C₃+12 H₂O=4 Al(OH)₃+3 CH₄

This formation of aluminum hydroxide is associated with an increase in volume, which can already lead to damage or destruction of the carbon-bonded brick. In particular, reheating a carbon-bonded brick containing such an aluminum hydroxide would lead to the destruction of the carbon-bonded brick due to dehydrogenation. Since it is also not possible to remove aluminum hydroxide from the carbon-bound brick, refractory carbon-bonded bricks containing Al₄C₃ cannot currently be recycled.

The invention is based on the object of providing a batch for the manufacture of a refractory carbon-bonded brick comprising an antioxidant to suppress oxidation of the carbon component, the antioxidant not forming hydratable substances during operation of the carbon-bonded brick.

A further object of the invention is to provide a process for producing a refractory carbon-bonded brick by which a refractory carbon-bonded brick can be produced which is effectively protected against oxidation of the carbon and in which no hydratable substances are formed during operation.

In order to solve the problem, according to the invention there is provided a batch for the production of a refractory carbon-bonded brick, which comprises the following components:

A refractory basic component;

a carbon component; and

Ti₂AlC.

The invention is based on the surprising basic knowledge that Ti₂AlC is a very effective antioxidant in batches for the production of refractory carbon-bonded bricks, which at the same time does not form any hydratable substances during the operation of the carbon-bonded brick which can be produced from the batches. According to the invention, Ti₂AlC has been found to be effective in suppressing carbon oxidation during the heating of the batch to produce the refractory carbon-bonded brick and during the operation of the carbon-bonded brick produced from the batch. The efficacy of Ti₂AlC is essentially equivalent to that of metallic aluminum as an antioxidant.

At the same time, Ti₂AlC does not form any hydratable substances or other substances during the heating of the batch and operation of the carbon-bonded brick, which would deteriorate the properties of the carbon-bonded brick during its operation or thereafter.

In particular, it also turned out, in accordance with the invention, that the use of Ti₂AlC as an antioxidant in generic batches for the production of a refractory carbon-bonded brick during the use of the carbon-bonded brick does not lead to the formation of any substances which would prevent the reusability of the carbon-bonded brick after its use. In this respect, carbon-bonded bricks in which Ti₂AlC was used as an antioxidant can be excellently recycled.

Ti₂AlC is a so-called MAX phase. MAX phases combine metallic and ceramic properties. In this respect, MAX phases, for example, have a high melting point, good thermal and electrical conductivity, high strength, good thermal shock resistance and can be easily machined with conventional tools. Ti₂AlC has thus far been used for turbine blades and heating elements, for example.

Surprisingly, the invention also revealed that the use of Ti₂AlC as an antioxidant in a batch to produce a refractory carbon-bonded brick can significantly improve the ductility of the carbon-bonded brick produced from the batch. In this respect, such a carbon-bonded brick exhibits improved brittleness behaviour or higher microstructural elasticity. This is shown in particular by a reduced modulus of elasticity (E-modulus) of refractory carbon bricks produced using Ti₂AlC as an antioxidant compared to those refractory carbon bricks produced without an antioxidant in the form of Ti₂AlC.

Preferably Ti₂AlC is present in a proportion in the range of 1 to 10% by mass in the batch, related to the total mass of the batch. If Ti₂AlC is less than 1% by mass, the effect of Ti₂AlC as an antioxidant and to improve the ductility of the carbon-bonded brick is reduced. If Ti₂AlC is present in an amount above 10% by mass in the batch, it was found according to the invention that in this case the properties of the refractory carbon-bonded brick produced from the batch could be impaired. In this respect, it was found according to the invention that the cold compressive strength of the carbon-bonded brick produced from the batch could be deteriorated in this case. The inventors suspect that this is due to the effect of the reaction products formed from Ti₂AlC during operation in the carbon-bonded brick. The inventors suspect, for example, that the aluminum content of Ti₂AlC reacts during operation with other substances of the batch to form substances which act as flexibilizers or elasticizers in the batch. The inventors suspect that the aluminum of Ti₂AlC, as far as the refractory basic component comprises a raw material based on magnesia, reacts with MgO of the basic component to form magnesia spinel (MgAl₂O4 or MgO—Al₂O₃), which acts as a flexibilizer in the carbon-bonded brick produced from the batch. It is known that the effectiveness of such flexibilizers in a refractory product is based on the fact that these microcracks form in the structure of the product, which increases the ductility of the product. However, above a certain percentage of flexibilizers, the strength of the product may drop sharply, so that flexibilizers can only be tolerated up to a certain percentage in a product. The inventors suspect that this tolerable proportion of a flexibilizer formed from Ti₂AlC and MgO is reached when Ti₂AlC is present with an upper limit of 10% by mass in the batch.

According to the invention, a refractory carbon-bonded brick produced from the batch has been found to have the best properties if the proportion of Ti₂AlC in the batch is present in a proportion in the range of 6 to 8% by mass in the batch. In this respect it can be provided that Ti₂AlC is present in a proportion of at least 1% by mass, more preferably in a proportion of at least 2% by mass, even more preferably in a proportion of at least 3% by mass and even more preferably in a proportion of at least 6% by mass. Furthermore, it may be provided that Ti₂AlC is present in a proportion of at most 10% by mass batch, more preferably in a proportion of at most 9% by mass and even more preferably in a proportion of at most 8% by mass.

It is preferred that Ti₂AlC is present in a proportion in the range from 1 to 10% by mass in batch, even more preferred in a proportion in the range from 2 to 9% by mass and even more preferred in a proportion in the range from 6 to 8% by mass.

Unless otherwise stated in the individual case, the information given herein in % by mass, insofar as it relates to the batch, is always related to the total mass of the batch.

Preferably Ti₂AlC is fine-grained, preferably as powder, especially preferred as powder with a grain size<63 μm

All of the grain sizes given here can be determined by sieve analysis, preferably according to DIN 66165-1:2016-08.

According to a preferred embodiment, it is provided that the fine-grained Ti₂AlC be granulated into granules in the batch according to the invention. These granules can preferably have a grain size in the range of 63 μm to 5 mm. For the production of such granules, fine-grained Ti₂AlC can be granulated to granules according to the state of the art technologies known from the production of granules, e.g. in a mixer or on a granulating plate.

According to the invention, Ti₂AlC can be used as an antioxidant in any desired batch for the production of a refractory carbon-bonded brick. For example, Ti₂AlC can be used in a batch to produce a magnesia carbon brick, to produce a non-basic carbon brick or to produce an alumina magnesia carbon brick.

The basic refractory component of the batch according to the invention may therefore comprise one or more refractory raw materials based on magnesia (MgO), alumina (Al₂O₃) or zirconia (ZrO₂). According to one embodiment, the refractory basic component consists of at least 90% by mass, preferably at least 95% by mass, of at least one of the oxides MgO, Al₂O₃ or ZrO₂. The mass percentages given here are based on the total mass of the basic component.

The refractory base component may, for example, comprise one or more of the following refractory raw materials: sintered magnesia, fused magnesia, sintered corundum, fused corundum, tabular alumina, magnesia spinel or zirconia.

According to one embodiment, the basic refractory component consists of one or more refractory raw materials based on magnesia or alumina, in particular one or more of the following refractory raw materials: sintered magnesia, fused magnesia, sintered corundum, fused corundum, tabular alumina, magnesia spinel or zirconia.

According to a particularly preferred embodiment, the batch according to the invention is used to produce a refractory magnesia carbon brick. This is as it turned out that Ti₂AlC has proven to be particularly effective in suppressing the oxidation of the carbon component in the production of magnesia carbon bricks. In particular, however, as explained above, it turned out that Ti₂AlC in this case can form flexibilizers with MgO of the basic component during operation, which can considerably improve the ductility of the magnesia carbon brick produced from the batch.

In this respect, according to one preferred embodiment, it is provide that the basic refractory component comprises one or more refractory raw materials based on magnesia. In this respect, according to a preferred embodiment, it may be provided that the refractory basic component consists of at least 90% by mass, preferably at least 95% by mass, of MgO. The data given before in % by mass are in each case related to the total mass of the basic component.

According to a preferred embodiment, it is provided that the basic refractory component comprises one or more of the following refractory raw materials: Sintered magnesia or fused magnesia. According to a preferred embodiment, the basic refractory component is provided to consist of one or more magnesia-based refractory raw materials, in particular one or more of the following: sintered magnesia or fused magnesia.

The proportion of the refractory basic component in the batch according to the invention is preferably in the range of 70 to 97% by mass, especially preferred in the range of 77 to 93% by mass.

The basic component is preferably in granular form, especially preferred in a grain size of 5 mm or less.

The proportion of the carbon component in the batch according to the invention is preferably in the range from 2 to 29% by mass, especially preferred in the range from 5 to 21% by mass.

The carbon component preferably consists of one or more solid carriers of free carbon as well as one or more cokable binders.

Solid carriers of free carbon are preferably in the form of one or more of the following raw materials: Graphite or carbon black. The solid carrier of free carbon in the form of graphite is particularly preferred. The solid carriers of free carbon of the carbon component are preferably present in a proportion in the range of 1 to 25% by mass batch, more preferably in a proportion in the range of 2 to 20% by mass and even more preferably in a proportion in the range of 4 to 15% by mass.

The cokable binders of the carbon component are present in the form of organic binders, i.e. on carbon-based binders that cake under the influence of temperature. Such coking binders are preferably present in the form of one or more of the following raw materials: Pitch or synthetic resin. The cokable binder in the form of synthetic resin is particularly preferred. The cokable binders of the carbon component are preferably present in a proportion in the range from 1 to 6% by mass, even more preferably in a proportion in the range from 2 to 6% by mass.

According to a preferred embodiment it is provided that the total mass of basic component, carbon component and Ti₂AlC in the batch is in the range of 95 to 100% by mass, more preferably in the range of 97 to 100% by mass and even more preferably in the range of 99 to 100% by mass. According to a preferred embodiment it is intended that the batch consists exclusively of the basic component, the carbon component and Ti₂AlC.

Accordingly, it can be provided that the batch, in addition to the base component, the carbon component and Ti₂AlC, contains further components in a total mass of less than 5% by mass, more preferably less than 3% by mass, even more preferably less than 1% by mass and even more preferably no further components.

In order to avoid the formation of hydratable substances in a refractory carbon-bonded brick produced from the batch according to the invention, it may be provided that the batch according to the invention does not contain metallic aluminum. In this respect, the proportion of metallic aluminum in the batch according to a preferred embodiment is less than 1% by mass and particularly preferred at 0% by mass (or less than the detection limit).

Since Ti₂AlC has also proven to be a more effective antioxidant than metallic silicon and, in contrast to silicon, can also, as explained above, increase the ductility of the carbon-bonded brick produced from the batch, it is provided in one embodiment that the batch according to the invention contains metallic silicon in a proportion of less than 1% by mass or also with 0% by mass (or below the detection limit).

The subject of the invention is also a process for the production of a refractory brick with a coke skeleton, which comprises the following steps: Provision of a batch according to the invention;

Application of temperature to the batch so that the carbon component undergoes coking and the batch forms a brick with a carbon network.

A brick produced by this process with a carbon network is characterized by a characteristic structure. This structure is formed from the basic component embedded in a carbon network of the carbon component or in a carbon network of the coking binder of the carbon component. The antioxidant Ti₂AlC is also embedded in the carbon network.

The components of the batch are preferably mixed with each other before they are subjected to temperature.

It can also be provided that the components of the batch, which may have been mixed together, are shaped before they are subjected to temperature, for example by pressing. For example, the batch can be formed into a shaped body before it is subjected to temperature, in particular by pressing.

The—possibly shaped—batch can be tempered before coking, i.e. it can be subjected to temperature in such a way that volatile components of the binder volatilize. The batch can preferably be tempered below a temperature of 350° C., especially preferably at a temperature in the range of 200 to 330° C.

Subjecting the batch with temperature such that the carbon component or the cokable binder of the carbon component cokes and the batch forms a refractory brick with a carbon network, is preferably done in a reducing atmosphere. For example, the batch—possibly shaped and, for example, tempered—can be embedded in a coal bed, for example in coal grit, during the application of temperature to form a reducing atmosphere.

Subjecting the batch with temperature such to form a carbon network is preferably done at a temperature in the range of 500 to 1,100° C., especially at a temperature in the range of 700 to 1,000° C., so that the carbon component cokes and the batch forms a refractory brick with a carbon network.

Both, a tempered batch obtained as above and a brick with a carbon network obtained as above already have a certain strength so that they can be transported and, for example, transported to the place of their intended use and installed there.

In particular, both a tempered batch obtained as above and a brick with a carbon network obtained as above may be used in a plant for the secondary metallurgical treatment of a steel melt, so that such a tempered batch or such a brick with a carbon network may be installed in such a plant for the secondary metallurgical treatment of a steel melt.

In order to produce a refractory carbon-bonded brick, i.e. a brick with a carbon bond, from the batch according to the invention, the brick formed with a carbon network can be further subjected to temperature in such a way that the carbon component forms a carbon bond.

Such further application of the carbon network to the brick to produce a carbon-bonded brick can preferably take place at a temperature in the range of 1,450 to 1,650° C., preferably in a reducing atmosphere. Preferably, this kind of exposure to temperature occurs during operation of the coked brick.

A refractory carbon-bonded brick produced from the batch according to the invention, in particular a carbon-bonded brick produced by the process according to the invention, is characterized by a characteristic microstructure and characteristic physical properties.

For example, a refractory carbon-bonded brick (i.e. a brick with a carbon bond) produced from the batch according to the invention, in particular also by the process according to the invention, may have a modulus of elasticity (E-modulus) below 8 GPa. At the same time, such a carbon-bonded brick can have a cold compressive strength in the range of 10 to 18 MPa. The modulus of elasticity is determined according to DIN EN ISO 12680-1:2007-05 and the cold compressive strength according to DIN EN 993-5:1998-12.

The structure of a carbon-bonded brick fired under a reducing atmosphere is characterized by the basic component embedded in a carbon matrix. Characteristic for a carbon-bonded brick fired under a reducing atmosphere are the presence of carbidic and nitridic phases based on titanium, which have formed from Ti₂AlC. These carbidic and nitridic phases can be one or more of the phases TiC, TiN and Ti₂CN. If the basic component comprises MgO, the presence of magnesia spinel in the area around the grains of the basic component and in the carbon matrix is also characteristic. In the areas of such a reducing fired brick in which it is exposed to an oxidic atmosphere at elevated temperatures, for example during operation, a characteristic mixed spinel of 2 MgO—TiO₂ and MgO—Al₂O₃ (Mg₉Al₂Ti₄O₂₀) can be found in addition to the basic component and the carbon matrix.

In addition, the characteristic phase perovskite (CaO—TiO2) can be found.

The invention also refers to the use of Ti₂AlC as an antioxidant in the production of carbon-bonded refractory batches, where Ti₂AlC can be used with the measures as set forth herein.

Further features of the invention result from the claims and the following examples of the invention.

All features of the invention can be combined individually or in combination.

For the following examples of the invention, a refractory basic component of fused magnesia, a carbon component of graphite and pitch and Ti₂AlC as antioxidant were provided.

The fused magnesia was made available in four grain fractions, namely in a grain fraction of 3 mm to 5 mm, in a grain fraction of 1 mm to <3 mm, in a grain fraction of 0.063 mm (63 μm) to <1 mm and in a flour fraction of <63 μm.

Ti₂AlC was provided in powder form with a particle size <63 μm. The Ti₂AlC was available both in powder form (ungranulated) and in the form of granules with a grain size of 2 mm to 4 mm and with a grain size of 0.063 mm (63 μm) to <2 mm.

On the basis of these components, two batches according to the invention were produced which are designated V2 and V3 in Table 1 below. Furthermore, a further batch was produced for comparison purposes, which is designated V1 in the following Table. The batch V1 has no Ti₂AlC as antioxidant in contrast to the batches V2 and V3. The data in Table 1 are data in % by mass, in each case related to the total mass of the respective batch.

TABLE 1

| Raw material | V1 | V2 | V3 |
|---|---|---|---|
| Fused magnesia 3-5 mm | 25.48 | 25.48 | 25.48 |
| Fused magnesia 1-<3 mm | 27.94 | 27.94 | 22.77 |
| Fused magnesia 0.063-<1 mm | 19.59 | 19.59 | 17.89 |
| Fused magnesia <0.063 mm | 13.72 | 6.89 | 13.72 |
| Graphite | 8.82 | 8.82 | 8.82 |
| Pitch | 0.98 | 0.98 | 0.98 |
| Synthetic resin | 3.47 | 3.47 | 3.47 |
| Ti₂AlC 2-4 mm (granulated) | — | — | 5.16 |
| Ti₂AlC 0.063-<2 mm (granulated) | — | — | 1.71 |
| Ti₂AlC <0.063 mm | — | 6.83 | — |

The batches were mixed and pressed to cylinders by pressing with a pressure of 140 MPa. These cylinders were first tempered under a reducing atmosphere for two hours at a temperature of 300° C., so that the volatile components of the pitch and the synthetic resin evaporated. The cylinders were then allowed to cool.

The cylinders were then heated to a temperature of 1,600° C. in a reducing atmosphere.

During heating, the pitch and the synthetic resin coked at about 700 to 900° C. and formed a carbon network, so that the cylinders were then available as coked bricks with a carbon network.

The coked bricks were further heated to 1,600° C. and subjected to a temperature of 1,600° C. for six hours in a reducing atmosphere. These bricks were then used to produce refractory carbon-bonded bricks, i.e. bricks with a carbon bond.

To create the reducing atmosphere, the cylinders were embedded in coal grit during the firing.

The structure of the carbon-bonded bricks obtained afterwards showed fused magnesia embedded in a matrix of carbon.

In addition, the carbon-bonded bricks produced from the batches V2 and V3 according to the invention showed the characteristic phases magnesia spinel, TiC, TiN and Ti₂CN. Ti₂AlC could no longer be detected. Furthermore, no traces of Al₄C₃ were detectable.

In addition, the carbon-bound bricks fired from the batches V2 and V3 according to the invention showed characteristic physical values. In particular, the carbon-bonded bricks produced from the V2 and V3 batches showed a significantly reduced modulus of elasticity compared to the carbon-bonded bricks produced from the V1 batch, with a still good cold compressive strength.

The physical values measured on the carbon-bonded bricks produced from the V1, V2 and V3 batches are given in Table 2 below. The carbon-bonded brick produced from batch V1 is marked V1, the carbon-bonded brick produced from batch V2 is marked V2 and the carbon-bonded brick produced from batch V3 is marked V3.

TABLE 2

| Physical Value | V1 | V2 | V3 |
|---|---|---|---|
| Δm/m₀ [%] | −4.38 | −1.19 | −2.42 |
| ΔV/V₀ [%] | 1.01 | 3.74 | 4.70 |
| E-Modulus axial [GPa] | 8.35 | 2.70 | 2.89 |
| E-Modulus radial [GPa] | 12.81 | 6.68 | 7.01 |
| Density [g/cm³] | 2.88 | 2.85 | 2.83 |
| Porosity [%] | 13.53 | 15.04 | 15.70 |
| Cold compressive strength [MPa] | 22.05 | 14.51 | 12.25 |

The value Δm/m₀ indicates the change in mass of the pressed cylinder not subjected to temperature compared to the carbon-bonded brick. Accordingly, ΔV/V₀ denotes the change in volume of the pressed cylinder not subjected to temperature compared to the carbon-bonded brick.

The lower mass decrease of the bricks V2 and V3 compared to the brick shows the effectiveness of Ti₂AlC as an antioxidant. In the case of bricks V2 and V3, the presence of Ti₂AlC suppressed the oxidation of carbon in the batch and its subsequent escape in the gas phase.

The modulus of elasticity (E-modulus) axial denotes the modulus of elasticity determined in the axial direction of the cylinder and the modulus of elasticity radial denotes the modulus of elasticity determined in the radial direction of the cylinder. The modulus of elasticity was determined in accordance with DIN EN ISO 12680-1:2007-05.

The density was determined according to DIN EN 993-1:1995-04.

Porosity is the measured open porosity and was also determined according to DIN EN 993-1:1995-04.

The cold compressive strength was determined according to DIN EN 993-5:1998-12.

The modulus of elasticity of bricks V2 and V3 is clearly reduced compared to brick V1. This indicates a significantly higher ductility of bricks V2 and V3 compared to brick V1.

At the same time, the V2 and V3 bricks show good values for the cold compressive strength.

1. Batch for producing a refractory carbon-bonded brick, comprising the following components:
1.1 a refractory basic component,
1.2 a carbon component,
1.3 Ti₂AlC.

2. Batch according to claim 1 with a proportion of Ti₂AlC in range from 1 to 10% by mass.

3. Batch according to claim 1, in which the refractory basic component comprises one or more magnesia, alumina or zirconia-based refractory raw materials.

4. Batch according to claim 1 in which the refractory basic component consists at least 90% by mass of at least one of the oxides MgO, Al₂O₃ or ZrO₂.

5. Batch according to claim 1 in which the refractory basic component comprises one or more of the following refractory raw materials: sinter magnesia, fused magnesia, sinter corundum, fused corundum, tabular alumina, magnesia spinel or zirconia.

6. Batch according to claim 1 in which the refractory basic components consists of one or more magnesia, alumina or zirconia-based refractor raw materials.

7. Batch according to claim 1 in which the refractory basic component consists of one or more of the following refractory raw materials: sinter magnesia, fused magnesia, sinter corundum, fused corundum, tabular alumina, magnesia spinel or zirconia.

8. Batch according to claim 1 with a proportion of the refractory basic component in the range from 70 to 97% by mass.

9. Batch according to claim 1 in which the carbon component consists of one or more carriers of free carbon as well as also of one or more coking binding agents.

10. Batch according to claim 9 with carriers of free carbon in the form of one or more of the following raw materials: graphite or soot.

11. Batch according to claim 1 with a proportion of the carbon component in the range from 2 to 29% by mass.

12. Method of producing a refractory brick with a coke network, comprising the following steps:
a. provision of a batch for producing a refractory carbon-bonded brick, the batch comprising the following components:
a refractory basic component,
a carbon component, and
Ti₂AlC;
b. application of temperature to the batch so that the carbon component undergoes coking and the batch forms a brick with a coke network.

13. Method of producing a refractory, carbon-bonded brick, comprising the steps according to claim 12 and the following further step:
c. application of temperature to the brick with a coke network so that the coked carbon component forms a carbon bond.

14. Refractory carbon-bonded brick, produced from a batch for producing a refractory carbon-bonded brick, the batch comprising the following components:
a refractory basic component,
a carbon component, and
Ti₂AlC, wherein the carbon-bonded brick has an E module below 8 GPa.

15. A method comprising using Ti₂AlC as an antioxidant in batches for producing carbon-bonded, refractory products.
